(19) United States
(12) Patent Application Publication
(10) Pub. No.: US 2016/0090774 A1
(43) Pub. Date: Mar. 31, 2016

(54) APPARATUS AND METHOD FOR A PORTABLE SELF STORAGE SYSTEM

(71) Applicant: Stop and Store Ltd., West Vancouver (CA)

(72) Inventor: Paul Donovan Reynolds, White Rock (CA)

(21) Appl. No.: 14/866,405

(22) Filed: Sep. 25, 2015

Related U.S. Application Data
(60) Provisional application No. 62/056,161, filed on Sep. 26, 2014.

(51) Int. Cl. E05G 1/00; G06Q 30/06; E05B 49/00; E05G 1/06; E05G 1/024; E05B 65/00

(52) U.S. Cl. CPC E05G 1/005; E05G 1/024; E05B 65/0075; E05B 49/00; E05G 1/06; G06Q 30/0645

(57) ABSTRACT

There is disclosed a portable self-storage system comprising a portable container, a portable fence comprising a keypad, wherein the portable fence surrounds the portable container, a portable light, wherein the portable light is a solar powered light that is portable, and a storage medium storing a program having instructions which when executed by a processor will cause the processor to control and operate the portable container, the portable fence, and the portable light.

### RELATED APPLICATION INFORMATION

This patent claims priority from the following provisional patent applications: U.S. Application No. 62/056,161 entitled, “Apparatus and Method for a Portable Self Storage System” filed Sep. 26, 2014.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to a method and system for portable re-locatable self-storage facility.

2. Brief Description

The present method and system maintains much of the look, layout and familiar appearance of traditional self-storage facilities. However, it is designed so that it can be quickly set up and operate at one site for several years then within weeks be packed up, relocated to another site and re-open for rental customers needing self-storage spaces.

Conventional self-storage facilities (and there are about 50,000 in the United States) are based on fixed building structures; fixed security fencing, fixed exterior night lighting and other fixed security systems. This leads to several problems.

Unpredictable Duration Prior to Construction: Due to the permanent buildings a project goes through zoning, development permitting, building permitting and then building inspections before operation. These steps take an unpredictable amount of costs and an unpredictable amount of time. A successful set of applications usually takes more than one year to obtain building permits.

Construction Cost Revisions and Delays: Permanent buildings may require re-design due to unexpected site conditions found during excavation of foundations. City building codes may require design changes or added features like fire-walls. Labor shortages; failed subcontractors; multiple trades to be coordinated; etc. can all trigger cost overruns and delays. A rental office on site, just one part of a storage facility, requires civil construction earthworks, framer, plumber, electrician, roofer, flooring contractors; finishing carpenter, office equipment supplier and cabinet maker. The scheduling and coordination issues often trigger delay or added cost claims.

Foundation failure: If a floating slab settles or cracks, or in-floor heating system fails, a remedy for these problems impacts many self-storage units all at once. None can be rented while the problems are resolved.

Impact of Renting via Staff: Using staff to rent to customers and collect payments has multiple cost impacts. In addition to wages there is the time needed to recruit and train; replacing staff who quit or have to be laid off due to cause; no one to deal with customers when the sole staff is outside cleaning or showing units, going to the bank, or off sick. Staff need to be supervised and re-trained. Staff require office space to be built, maintained, and equipped. A toilet has to be built and serviced. These require installation and maintenance of phone, fax, internet, computers, alarm, hot water, electrical system and optic cable. Each of these office items has utility costs. Each has capital costs and on-going operational cost impacts.

### DESCRIPTION OF THE DRAWINGS

FIG. 1 is a block diagram of a portable self-storage system.

FIG. 2 is a block diagram of an environment for using a portable self-storage system.

FIG. 3 is a block diagram of a computing device.

FIG. 4 is a flowchart of a method for developing a portable self-storage system.

### DETAILED DESCRIPTION

The method and system described herein provide a comprehensive self-storage solution—from the physical storage unit to the operational infrastructure—and enables anyone to own and operate a successful self-storage business, without any prior experience.

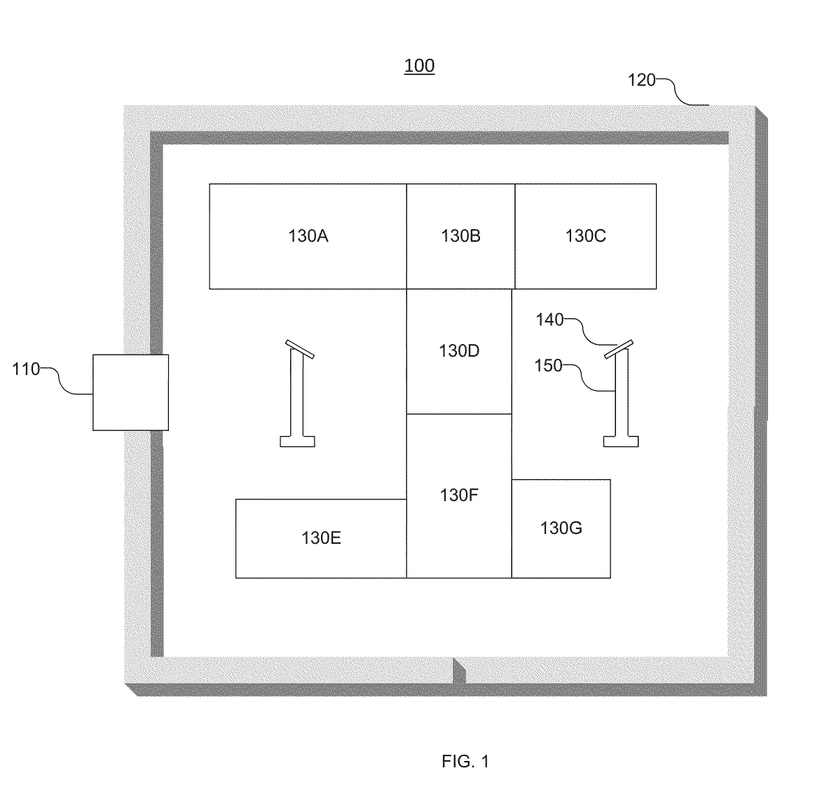

Referring now to FIG. 1, there is shown a block diagram of a portable self-storage system 100. The system 100 includes an electronic gate 110, an exterior barrier 120, portable containers 130A-130G, a portable light base 150 and a portable light panel 140. The system may be developed on any size of land. The system 100 utilizes a piece of land which does not have an obvious or immediate preferred use, then the system is used to create a valuable storage system. This could be a redundant building or piece of land. It may be independent or attached to other premises that are in use. Other examples include: car parks, yards (graveled or other hard surfaces), development sites which are unlikely to secure planning permits for some years, large farm buildings, surplus land, land bank awaiting annexation, and many more.

The system described is customizable, thereby not requiring a minimum amount of land. The system is customizable to a smaller land sites than conventional self-storage which generally needs at least two acres of land at a minimum. Because it can operate on a smaller site than permanent storage facilities it enables creating self-storage facilities into new markets and conveniently closer to residential areas. There is no minimum size of land or building and the site could be a combination of both. It may be best for the portable self-storage system is that the land be graveled or tarmac surface or a building with a concrete floor and a main power supply may be needed if lighting and electronic gating are desired.

The portable self-storage system has beneficial features, such as (1) it does not require a full time staff; (2) low operational costs and no office at site; (3) a facility can be set up and operate within two weeks; (4) simple assembly means new storage units can be ready in 30 minutes; (5) a facility can be disassembled in a short amount of time (e.g. one week) if the site is required for an alternative use; (6) transport costs are lowered by using flat packed storage units; (7) a variety of unit sizes meet individual customer requirements; and (8) size variety enables the most efficient use of the land.

The electronic gate 110 may be or include an electronic display. The display may include a touchscreen interface, such that a user may input a passcode to enter the system 100. Alternatively, the electronic gate 110 may comprise fingerprint recognition software, such that a user of the portable self-storage system 100 may provide their fingerprint in order to obtain access to the portable self-storage system 100. The key pad is directly linked to the management software so if a customer has not paid the rent when it was due, then the keypad number is temporarily deactivated until the customer has paid the rent.

The exterior barrier 120 may be in the form of a gate, door or fence. Alternatively, the exterior barrier may comprise a portable upright structure that serves as a boundary between the portable self-storage system 100 and the nearby area.

The system 100 also comprises portable containers 130A-130G. The portable containers arrive on site prefabricated and flat packed. The portable containers may be constructed of steel. Alternatively, the portable containers may be constructed of any material that is durable and can support furniture and other storage items. The portable containers may take as little as 30 minutes each to install and configure, and no heavy construction equipment is necessary. Specifically, the portable container may be setup without even needing equipment such as a fork lift. In addition, the portable containers may be able to be collapsed quickly, in as little fifteen minutes. All of the portable containers are free standing. In other words, the portable containers are not fixed to the ground. Rather, these portable container do not require any structural support relative to the ground. The portable containers may also contain a keypad located on the front of the portable container, to permit entry into the portable container.

The portable containers 130A-130G may be created in different sizes. For example, a portable container may be approximately 7′×7′×7′. Alternatively, the portable container may be approximately 12′×12′×7′. The system may include portable containers of varying sizes based on the desired request for the size of the container.

After the portable containers 130A-130G are installed, the portable containers 130A-130G may be “bolted” together. The containers may be “bolted” together using fastener material to connect the portable containers to each other. A small portable container may be bolted to a larger portable container. In FIG. 1, portable container 130A is shown to be significantly larger than portable container 130B. While portable container 130A and portable container 130B vary in size, these containers still may be bolted together. Each portable container may be accessed using a key, combination lock, electronic lock or other, individual gating element.

The system 100 also comprises solar powered movable and portable lighting 140 and 150. The portable lighting may comprise a portable light base 150 and a portable light panel 140. As with the portable containers, the portable lights may not fixed to the ground. Instead, they may be free standing lighting fixtures that are easily transportable. Shown in FIG. 1, the portable light comprises a portable light base 150 and a portable solar panel 140. The portable lighting may comprise solar lighting, or lamps. Because the lighting is not attached to the local power grid it can be set up in hours; and is ready to relocate to a new site when the portable containers are relocated.

The system 100 may also include Closed-Circuit Television (CCTV) (not shown). The CCTVs may be included as a safety mechanism so as to have video surveillance of the people approaching the key pad entry system or the portable storage system.

If a landowner secures a more profitable use for the land then the system can be easily dismantled and relocated to a new site in the same area or to a different town.

Locations on or near a busy road with adequate vehicular access and close to urban areas are preferable but not essential.

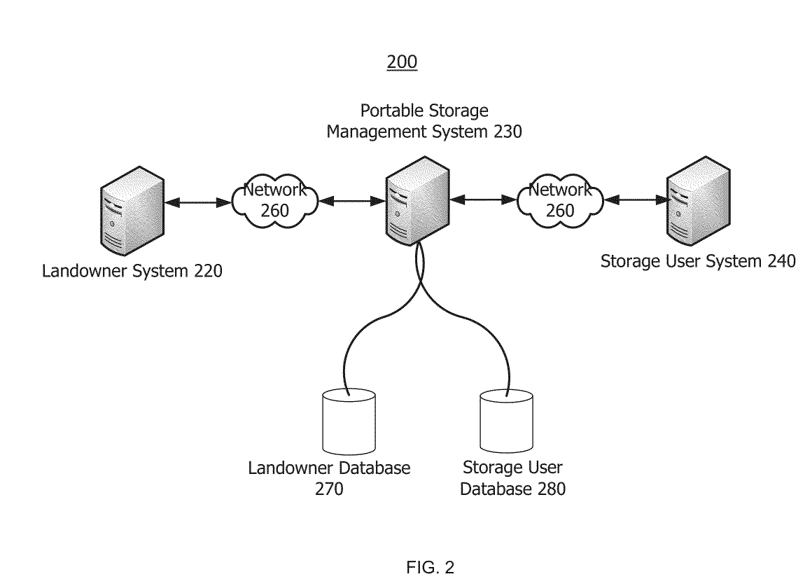

Referring now to FIG. 2, there is shown a block diagram of an environment 200 of a portable self-storage system. The environment 200 includes a landowner system 220, a portable storage management system 230, a storage user system 240 and a network of computers 260. The portable storage management system 230 may comprise multiple databases such as a landowner database 270 and a storage user database 280. The portable storage management system 230 may be operated by an operator and may be integrated with other IT systems of the operator.

Various people may operate aspects of the portable self-storage system. For example, an individual who works for the landowner may operate the landowner system 220. Similarly, the storage user system 240 may be operated by a customer using the portable self-storage system. A customer can select a unit; complete and sign a rental agreement, receive an access code on line. The customer receives the contract via email with the access code for the key pad and directions to the site. The customer can then access the site and move themselves into the rented portable container. In the same way, the customer can move themselves out of the container, pay their final bill on line and “check out” of the management system. The system 240 then notifies management to clean the portable container and prepare it for the next renter. Each user may have secure access and control over his respective system. Furthermore, users may obtain the functionality hereof through non-specified devices having the capability of performing the functionality described herein.

The portable storage management system 230 may be a computer system having server software such as web server software. The portable storage management system 230 may include one or more databases, such as a landowner database 270 and a storage user database 280. The partitioning of the databases 270 and 280 into the two functional units as shown is for ease of discussion and does not imply a corresponding physical division or structure. Though described as part of the portable storage management system 230, the databases 270 and 280 may be stored elsewhere or otherwise distributed. The portable storage management system 230 may store in the databases metadata arising from transactions. The landowner database 270 may comprise information regarding the landowner requesting the portable self-storage system. A “landowner” may be a land owner who owns bare land, or land with a structure on it, or an individual leasing the associated land from the true landowner. In addition, a landowner may be an individual, or a company that a land owner has hired to create a portable self-storage system. The storage user database 280 may comprise information regarding a user of the portable self-storage system. For example, the storage user database 280 may comprise personal information for the user, and a passcode for the user to enter the portable self-storage facility. In addition, the storage user database 280 may comprise information regarding additional individuals that the user permits to access the portable self-storage system 240.

The landowner system 220 and the storage user system 240, which are representative of a number of customer systems, may be computer systems and may include web browser software which allow them to browse the portable storage management system 230 and engage in transactions with the portable storage management system 230.

The network 260 is a data network, and may be or include the Internet. The network 260 and the systems communicating through the network 260 may support secure communications with the portable storage management system 230.

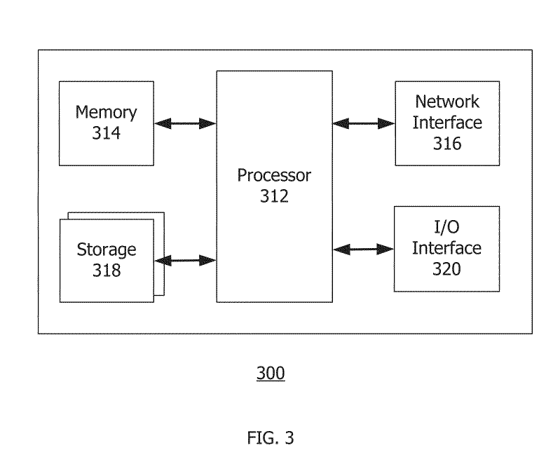

Turning now to FIG. 3, there is shown a block diagram of a computing device 300, which is representative of the portable storage management system 230, the landowner system 220 and the storage user system 240 in FIG. 1. The computing device 300 may be, for example, a desktop or laptop computer, a server computer, a tablet, or other mobile or smart device. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 has a processor 312 coupled to a memory 314, storage 318, a network interface 316 and an I/O interface 320. The processor 312 may be or include one or more microprocessors and application specific integrated circuits (ASICs).

The memory 314 may be or include RAM, ROM, DRAM, SRAM and MRAM, and may include firmware, such as static data or fixed instructions, BIOS, system functions, configuration data, and other routines used during the operation of the computing device 200 and processor 312. The memory 314 also provides a storage area for data and instructions associated with applications and data handled by the processor 312.

The storage 318 provides non-volatile, bulk or long term storage of data or instructions in the computing device 300. The storage 318 may take the form of a magnetic or solid state disk, tape, CD, DVD, or other reasonably high capacity addressable or serial storage medium. Multiple storage devices may be provided or available to the computing device 300. Some of these storage devices may be external to the computing device 300, such as network storage or cloud-based storage. As used herein, the term storage medium corresponds to the storage 318 and does not include transitory media such as signals or waveforms. In some cases, such as those involving solid state memory devices, the memory 314 and storage 318 may be a single device.

The network interface 316 includes an interface to a network such as the network 260 (FIG. 2). The network interface 316 may be wired or wireless.

The I/O interface 320 interfaces the processor 312 to peripherals (not shown) such as displays, keyboards and USB devices.

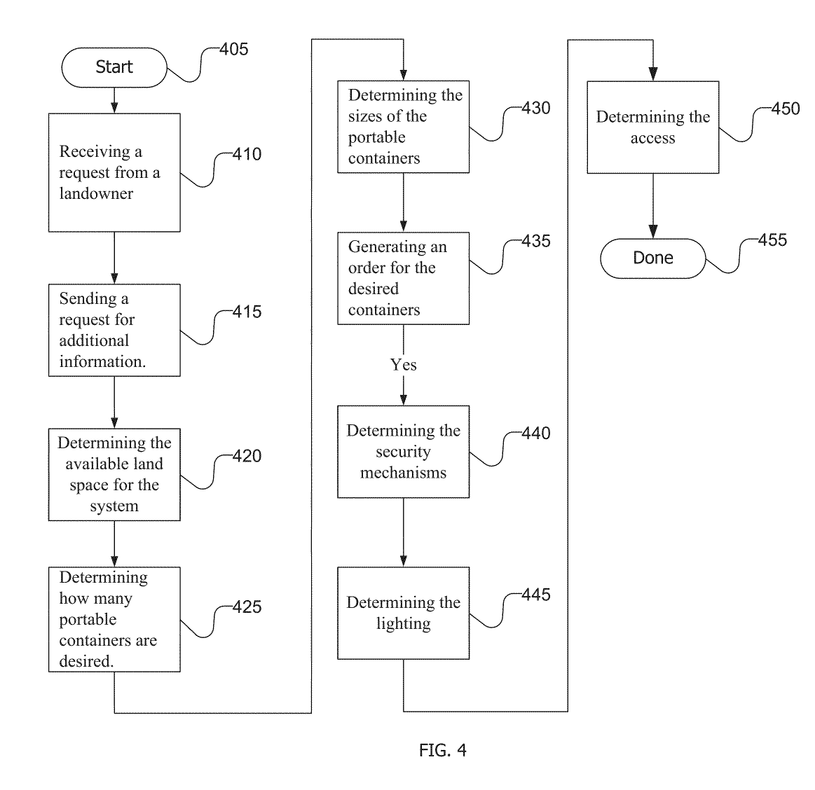

Referring now to FIG. 4, there is shown a flowchart of a method for developing a portable self-storage system. The method may use the environment 200 of FIG. 2, and in particular the portable self-storage management system 230. The flow chart has both a start 405 and end 455, but the process is cyclical in nature.

Self-storage is used by both business and residential customers for numerous reasons. Residential customers have the requirement for reasons such as moving home, marriage, divorce, and downsizing.

Businesses use self-storage for a number of reasons including; storing inventory seasonal displays, furniture and archives. The common denominator is they all require extra space on a flexible basis.

The process begins at 410 when a portable self-storage management system, such as portable self-storage management system 230 receives a request from a landowner to create a portable self-storage system. For example, a landowner can use a landowner system, such as landowner system 220 in FIG. 2, to send a request to a portable self-storage management system for more information.

Next, at 415, the portable self-storage management system may send a message back to the landowner system, requesting additional information regarding the size and container requirements for the portable self-storage system.

The process then moves to 420, in which the landowner uses a landowner system, such as landowner system 220 of FIG. 2, to provide information regarding the size of the land available for the portable self-storage system. For example, the portable self-storage management system, may send an email to the landowner with a questionnaire with questions regarding the land available for the portable self-storage system. The questionnaire may enquire whether the land is near any other building structures, the size of the land, and any obstructions on the land that may prevent using the full land site as part of the portable self-storage system. Once the landowner provides all of this information, the portable self-storage management system may store that information in a database in order to utilize the information in the development of the portable self-storage system.

The process then moves to 425, in which the landowner uses a landowner system, such as landowner system 220 of FIG. 2, to determine how many portable containers are desired. For example, the portable self-storage management system, may send an email to the landowner asking if the landowner anticipates a large number of users, in which case the portable self-storage management system may suggest numerous small to mid-sized portable containers. The process may implement this by sending the landowner system with a questionnaire with questions regarding the types of users, local population demographics within a defined radius of the proposed site that may utilize the portable self-storage system. This question may be sent along with the questionnaire described with respect to step 420.

For example, if the landowner anticipates many residential users, then the landowner may request numerous small to medium sized portable containers. Alternatively, if the landowner anticipates mostly commercial users, then the landowner may request a few, larger sized portable containers. The questionnaire may enquire about the type of the user, as well as an average time frame as to how long a user may need to use the portable self-storage system. Once the landowner provides all of this information, the portable self-storage management system may store that information in a database in order to utilize the information in the development of the portable self-storage system.

The process then moves to 430, in which the landowner uses a landowner system, such as landowner system 220 of FIG. 2, to determine the sizes of the portable containers that are desired. As with determining the quantity of portable containers, this determination may be made by understanding the nature of the customers of the portable self-storage system. For example, if the landowner anticipates more residential users, then the landowner may request numerous small to medium sized portable containers. Alternatively, if the landowner anticipates mostly commercial users, then the landowner may request a few, large sized portable containers or large containers inter-linked to be a single larger unit. The land owner provides the following additional information which is imputed as data into the portable storage management system: dimensions of the land site; local zoning set back requirements; local fire department requirements for drive lane widths; local traffic regulations for minimum entrance clearance and customer parking; and then creates optimal site layouts using various unit sizes. This leads to a decision on the optimal site layout and precise numbers of containers of specified mix of sizes.

The process then moves to 435, in which the portable self-storage management system generates an order for the desired number of portable containers, as well as their respective sizes. The order will be stored in the portable self-storage management system's database. Storing this information will be beneficial in the event that the same landowner desires to create another similar portable self-storage system in another location. After the order for the portable containers has been generated, then the portable self-storage management system will notify the manufacturer of the portable containers to create the required number of portable containers in the designated mix of sizes.

The process then moves to 440 to determine the security mechanisms for the portable self-storage system. For example, the landowner may request closed-circuit television in order to provide 24×7 video surveillance of the portable self-storage system to its users. The users may be able to access the video surveillance from an electronic device by entering a website and a passcode. After logging in, the user may be able to see live video coverage of the portable self-storage system, so as to ensure their portable containers are secure. The system may determine the security mechanisms by sending a questionnaire to the landowner to determine what kind of security mechanisms are desired. For example, in addition to the closed-circuit televisions, the landowner may request an alarm to be placed on the fence, or barrier, enclosing the portable self-storage system. Once this information is determined, the portable self-storage management system may store this information in a database.

The process then moves to 445 to determine the lighting for the portable self-storage system. For example, the landowner may prefer to only use solar lighting. Alternatively, the landowner may prefer to use traditional street lights. Similar to the other features, the system may determine the lighting by sending a questionnaire for the landowner to indicate the preferred lighting and how much lighting is desired. Once this information is determined, the portable self-storage management system may store this information in a database.

The process then moves to 450 to determine how a user of the portable self-storage system may access the facility. For example, the electronic gate, such as electronic gate 110 of FIG. 1, may require a user to provide a fingerprint in order to access the portable self-storage system. Alternatively, the system may have facial recognition software to determine whether to provide access to the portable self-storage system. In addition, the system may require the user to enter a unique passcode to determine whether to provide access to the portable self-storage system. Once this information is determined, the portable self-storage management system may store this information in a database for implementation of the access protocols.

Following determining the various aspects of the portable self-storage system, the process is done. The portable self-storage system may include additional features not disclosed. For example, the portable self-storage system may include security officers who periodically parole the portable self-storage system.

It is claimed:

1. A portable self-storage system comprising:
a portable container;
a portable fence comprising a keypad, wherein the portable fence surrounds the portable container;
a portable light, wherein the portable light is a solar powered light that is portable; and
a storage medium storing a program having instructions which when executed by a processor will cause the processor to control and operate the portable container, the portable fence, and the portable light.

2. The system of claim 1, wherein the storage medium further comprises instructions which when executed will cause the processor to determine a number of portable containers for a site layout plan and generate an order for a manufacturer to create a the number of portable containers.

3. The system of claim 1 wherein the storage medium includes instructions for opening the portable fence when a code is entered on the keypad.

4. The system of claim 1 wherein the portable container includes a keypad to obtain access to the portable container.

5. The system of claim 1, further comprising a second portable container, wherein the second portable container is bolted to the portable container by using a metal fastener.

6. The system of claim 1, further comprising a closed-circuit television that is installed within the system.

7. The system of claim 5 wherein the second portable container is smaller in size than the first portable container.

8. A method for creating a portable self-storage system comprising:
determining a size of a land that is available for the portable self-storage system;
determining a number of portable containers;
determining a security mechanism for monitoring the portable self-storage system; and
determining a portable light for the portable self-storage system; and
installing the number of portable containers, the portable light, and the security mechanism, wherein the installation occurs in less than two weeks.

9. The method of claim 8, wherein access to the portable self-storage system is provided by using a keypad on the entrance to the portable self-storage system.

10. The method of claim 9, wherein a user uses his fingerprint to obtain access to the portable self-storage system.

11. The method of claim 8, wherein the installation further comprises bolting the portable containers to each other.
